(19) United States
(12) Patent Application Publication
(10) Pub. No.: US 2024/0312738 A1
(43) Pub. Date: Sep. 19, 2024

(54) TRIGGER SWITCH

(71) Applicant: OMRON Corporation, KYOTO (JP)

(72) Inventors: Takumi FUJIHARA, Kyoto-shi (JP); Taiki KOYAMA, Kyoto-shi (JP); Kazushi MAETA, Kyoto-shi (JP); Yohei TSUKANAKA, Kyoto-shi (JP)

(73) Assignee: OMRON Corporation, KYOTO (JP)

(21) Appl. No.: 18/581,342

(22) Filed: Feb. 19, 2024

(30) Foreign Application Priority Data
Mar. 16, 2023 (JP) 2023-041487

(51) Int. Cl. H01H 13/68; B25F 5/00; H01H 13/08

(52) U.S. Cl. CPC H01H 13/68; H01H 13/08; B25F 5/00; H01H 2231/048

(57) ABSTRACT

A trigger switch TS includes a trigger that moves in a pulling direction in response to pressure of a pulling operation and moves in an opposite direction to the pulling direction in response to being released from the pressure. The trigger switch TS includes a lock guide 6 (movable engagement member) that moves in conjunction with movement of the trigger, and a ratchet ring 7 (restraint engagement member) that engages with the lock guide 6 to prevent movement of the lock guide 6 in the opposite direction to the pulling direction. The ratchet ring 7 allows the lock guide 6 to move in the pulling direction, and engages with the lock guide 6 to prevent movement in the opposite direction from a position to which the lock guide 6 is moved in the pulling direction.

### CROSS-REFERENCE TO RELATED APPLICATION

This application claims the priority benefits of Japanese application no. 2023-041487, filed on Mar. 16, 2023. The entirety of the above-mentioned patent application is hereby incorporated by reference herein and made a part of this specification.

### BACKGROUND

### Technical Field

The disclosure relates to a trigger switch including a trigger that moves in a pulling direction in response to pressure of a pulling operation and moves in the opposite direction to the pulling direction when released from the pressure.

### Description of Related Art

Trigger switches that accept pulling operations are used in power tools such as electric screwdrivers. A trigger switch used to control the drive of a power tool includes a trigger that moves in a pulling direction in response to pressure of a pulling operation and is urged to move in the opposite direction to the pulling direction when released from the pressure. Such a trigger switch has various functions. For example, Patent Document 1 (Japanese Patent Application Laid-Open No. 2016-219321) discloses a trigger switch that maintains the pulled state with a locking member in an on state where a trigger operator is pulled in. In addition, there is a commercially available trigger switch, for example, that is incorporated into a power tool, which has a function of changing the speed of a drive part, and controls the drive speed of the drive part to vary according to the amount of movement caused by the pulling operation.

However, the locking for the on state of the conventional trigger switch as described in Patent Document 1 is limited to locking in a state where the trigger is pulled to a position where pulling is allowed. Therefore, even though the conventional trigger switch has a function of changing the drive speed according to the amount of movement caused by the pulling operation, it is difficult to fix the trigger at any pull-in position and drive at a constant speed.

The disclosure provides a trigger switch that allows the trigger to be fixed at any position.

### SUMMARY

A trigger switch according to an embodiment of the disclosure includes a trigger that moves in a pulling direction in response to pressure of a pulling operation and moves in an opposite direction to the pulling direction in response to being released from the pressure; a movable engagement member that moves in conjunction with movement of the trigger; and a restraint engagement member that prevents movement of the movable engagement member in the opposite direction to the pulling direction by engaging with the movable engagement member. The restraint engagement member allows movement of the movable engagement member in the pulling direction, and engages with the movable engagement member to prevent movement in the opposite direction from a position to which the movable engagement member is moved in the pulling direction.

Further, in the trigger switch, the movable engagement member includes ratchet teeth arranged along a movement direction, the restraint engagement member includes a ratchet pawl, and the ratchet teeth of the movable engagement member and the ratchet pawl of the restraint engagement member engage so that the movable engagement member and the restraint engagement member engage.

Further, in the trigger switch, the restraint engagement member includes an urging member that urges the ratchet pawl toward the ratchet teeth.

Further, the trigger switch according to an embodiment of the disclosure further includes a release operation part that receives an operation to release the movable engagement member from engagement with the restraint engagement member.

The trigger switch according to an embodiment of the disclosure achieves excellent effects such as fixing the trigger at any position through engagement between the movable engagement member and the restraint engagement member.

### BRIEF DESCRIPTION OF THE DRAWINGS

FIG. 1 is a schematic perspective view showing an example of the appearance of a power tool incorporating the trigger switch according to an embodiment of the disclosure.

FIG. 2 is a schematic perspective view showing an example of the appearance of the trigger switch according to an embodiment of the disclosure.

FIG. 3 is a schematic exploded perspective view showing an example of the trigger switch according to an embodiment of the disclosure.

FIG. 4 is a schematic perspective view showing an example of the lock guide included in the trigger switch according to an embodiment of the disclosure.

FIG. 5 is an exploded perspective view showing an example of the housing included in the trigger switch according to an embodiment of the disclosure.

FIG. 6A is a schematic perspective view showing an example of the ratchet ring included in the trigger switch according to an embodiment of the disclosure.

FIG. 6B is a schematic perspective view showing an example of the ratchet ring included in the trigger switch according to an embodiment of the disclosure.

FIG. 7 is a schematic cross-sectional view showing an example of the ratchet ring included in the trigger switch according to an embodiment of the disclosure.

FIG. 8 is a schematic view schematically showing an example of the ratchet mechanism of the trigger switch according to an embodiment of the disclosure.

FIG. 9 is a schematic view schematically showing an example of the ratchet mechanism of the trigger switch according to an embodiment of the disclosure.

FIG. 10 is a schematic side view showing an example of the ratchet mechanism of the trigger switch according to an embodiment of the disclosure.

FIG. 11 is a schematic cross-sectional view showing an example of the ratchet mechanism of the trigger switch according to an embodiment of the disclosure.

FIG. 12 is a schematic side view showing an example of the ratchet mechanism of the trigger switch according to an embodiment of the disclosure.

FIG. 13 is a schematic cross-sectional view showing an example of the ratchet mechanism of the trigger switch according to an embodiment of the disclosure.

FIG. 14 is a graph showing an example of the relationship between the stroke and the rotation speed of the trigger switch according to an embodiment of the disclosure.

FIG. 15 is a schematic perspective view showing the release operation part included in the trigger switch according to an embodiment of the disclosure and the vicinity thereof.

FIG. 16 is a schematic perspective view showing the release operation part included in the trigger switch according to an embodiment of the disclosure and the vicinity thereof.

FIG. 17 is a schematic cross-sectional view showing the release operation part included in the trigger switch according to an embodiment of the disclosure and the vicinity thereof.

### DESCRIPTION OF THE EMBODIMENTS

Embodiments of the disclosure will be described hereinafter with reference to the drawings.

### Application Example

The trigger switch according to an embodiment of the disclosure is suitable as the switches of various electric devices including power tools such as electric drills, electric screwdrivers, electric wrenches, and electric grinders. In the following embodiment, a trigger switch TS incorporated in such a power tool PT will be exemplified and described with reference to the drawings.

### Structure Example

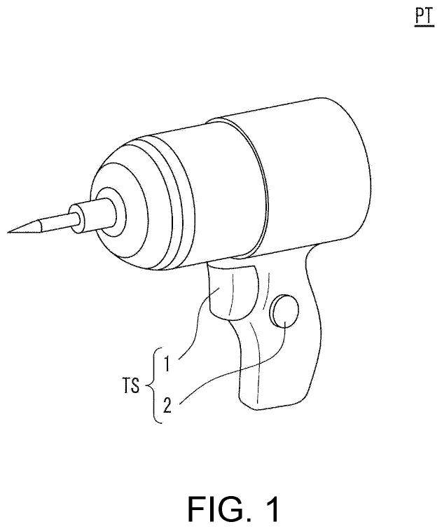

FIG. 1 is a schematic perspective view showing an example of the appearance of the power tool PT incorporating the trigger switch TS according to an embodiment of the disclosure. The trigger switch TS according to an embodiment of the disclosure is incorporated into the power tool PT such as an electric drill, an electric screwdriver, an electric wrench, and an electric grinder to be used. The trigger switch TS is a switch operated by the user of the power tool PT. The trigger switch TS incorporated into the power tool PT includes operation parts such as a trigger 1 that accepts an operation from the user and a release operation part 2, and the operation parts are exposed to the outside of the power tool PT. FIG. 1 exemplifies a released state in which the user is not operating the trigger switch TS. When the user performs a pulling operation on the trigger switch TS from the released state illustrated in FIG. 1, a drive part (not shown) such as an electric motor built in the power tool PT is driven. Further, the trigger switch TS according to an embodiment of the disclosure is capable of fixing the pulled trigger 1 at any position. The trigger 1 fixed at a position is released by operating the release operation part 2.

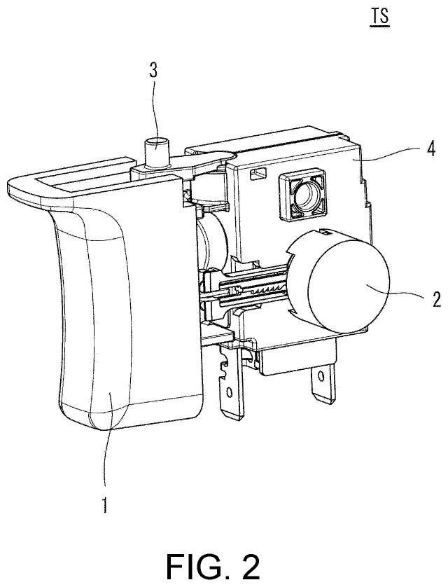

FIG. 2 is a schematic perspective view showing an example of the appearance of the trigger switch TS according to an embodiment of the disclosure. The trigger switch TS includes the trigger 1 that accepts a pulling operation, the release operation part 2 that accepts a release operation, a switching lever 3 that accepts a switching operation, and a housing 4 to which the trigger 1, the release operation part 2, and the switching lever 3 are attached. The housing 4 has a substantially rectangular parallelepiped shape. In the following description, the directions of the trigger switch TS are expressed as follows: the direction in which the trigger 1 is arranged with respect to the housing 4 is referred to as front, the direction in which the release operation part 2 is arranged is referred to as left, and the direction in which the switching lever 3 is arranged is referred to as up. These directions are defined for convenience of explanation and do not limit the direction in which the trigger switch TS is used.

The trigger 1 arranged on the front side of the housing 4 is a member for placing a finger when the user performs a pulling operation. When the user places a finger on the trigger 1 and pulls the trigger 1 rearward, the trigger 1 receives pressure from the pulling operation and moves rearward in the pulling direction. A return spring that presses the trigger 1 forward is incorporated into the housing 4. Therefore, when the trigger 1 is released from the pressure of the pulling operation, the trigger 1 moves forward, which is the opposite direction to the pulling direction. It should be noted that, as will be described later, the trigger 1 can be fixed at any position by preventing the trigger 1 from moving forward from the position to which the trigger 1 is moved in the pulling direction by the pulling operation.

The release operation part 2 arranged on the left side surface of the housing 4 is an operation part such as a dial or a button that accepts an operation to release the trigger 1 fixed at any position. By operating the release operation part 2, it is possible to set whether to fix the trigger 1 at the position to which the trigger 1 is pulled.

The switching lever 3 arranged on the upper surface of the housing 4 is a member that swings left and right in response to an operation of switching the drive direction of the drive part from the user. Further, when the switching lever 3 is operated to be located in the middle of the swing range, the switching lever 3 functions as a stopper that prevents the pulling operation.

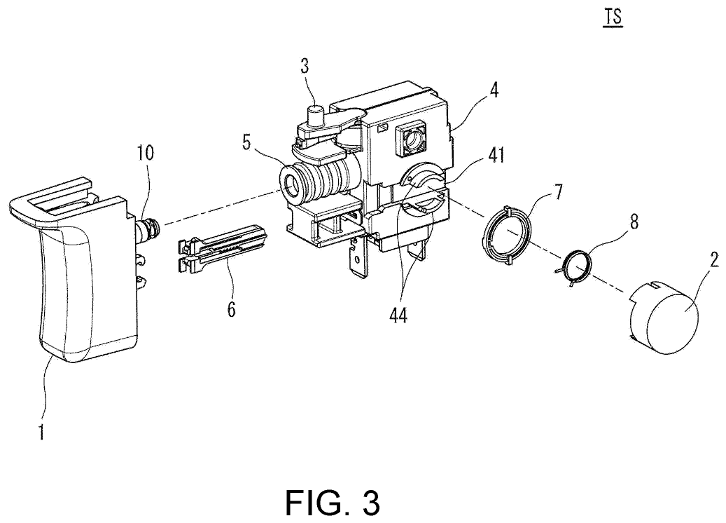

FIG. 3 is a schematic exploded perspective view showing an example of the trigger switch TS according to an embodiment of the disclosure. The trigger switch TS includes members such as a covering member 5, a lock guide 6 (movable engagement member), a ratchet ring 7 (restraint engagement member), and a torsion spring 8 (urging member) in addition to the trigger 1, the release operation part 2, the switching lever 3, and the housing 4.

The trigger 1 is a member that accepts a pulling operation of the user, and the front surface of the trigger 1 has a curved shape for the user to easily place a finger thereon during operation. The trigger 1 has a shaft-shaped plunger 10 attached to the rear surface. The plunger 10 is arranged to pass through a through hole 40 (see FIG. 5) formed on the front surface of the housing 4. A portion of the plunger 10 located outside the housing 4 is covered with the covering member 5. The covering member 5 is formed in a substantially cylindrical bellows shape, and covers the plunger 10 in the circumferential direction on the outside of the housing 4. The covering member 5 is a packing formed using a flexible and airtight material such as rubber, and expands and contracts in the axial direction and seals the inside.

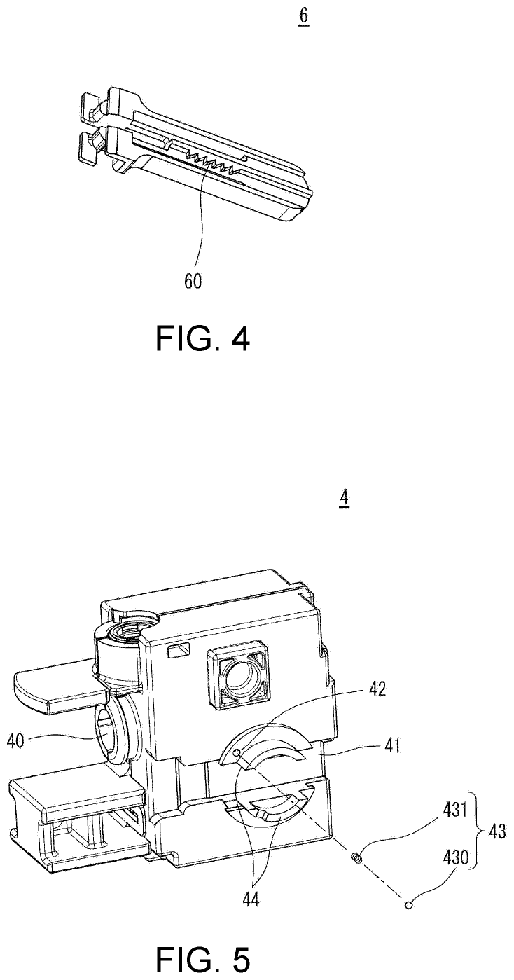

The elongated lock guide 6 is attached to the rear left side of the trigger 1 with the longitudinal direction of the elongated lock guide 6 corresponding to the front-rear direction (movement direction). FIG. 4 is a schematic perspective view showing an example of the lock guide 6 included in the trigger switch TS according to an embodiment of the disclosure. The lock guide 6 will be described using FIG. 3 and FIG. 4. The lock guide 6 moves back and forth in conjunction with the forward and rearward movement of the trigger 1. The lock guide 6 is fitted into a regulation groove 41 formed on the left side surface of the housing 4 and extending in the front-rear direction. The movement direction of the lock guide 6 is regulated by the regulation groove 41, and the lock guide 6 moves back and forth along the regulation groove 41. The lock guide 6 has ratchet teeth 60 arranged near the center in the vertical width direction along the longitudinal direction, which is the movement direction. The ratchet teeth 60 of the lock guide 6 are formed in a downward sawtooth shape. Each tooth constituting the ratchet teeth 60 of the lock guide 6 has a shape that the front side is a vertically steep lower tooth and the rear side is a sloped back tooth.

FIG. 5 is an exploded perspective view showing an example of the housing 4 included in the trigger switch TS according to an embodiment of the disclosure. The housing 4 will be described using FIG. 3 and FIG. 5. The housing 4 is a hollow case having a substantially rectangular parallelepiped shape. The housing 4 accommodates various circuits (not shown) that are operated by the trigger 1 and the switching lever 3. When the trigger 1 receives a pulling operation and moves in the pulling direction, the plunger 10 at the rear of the trigger 1 moves in the pulling direction. The movement of the plunger 10 in the pulling direction activates the circuits within the housing 4 so that the drive part of the power tool PT is driven at a rotation speed corresponding to the amount of movement of the plunger 10. Since the housing 4 accommodates a return spring (not shown) that urges the plunger 10 in the opposite direction to the pulling direction, the user can feel the load that increases in accordance with the pulling amount of the trigger 1. When the trigger 1 is released from the pressure caused by the pulling operation of the user, the plunger 10 and the trigger 1 are moved forward by the urging force of the return spring. Furthermore, when the switching lever 3 receives a switching operation, the circuits within the housing 4 are switched so that the drive direction of the drive part of the power tool PT is switched.

As described above, the housing 4 has the through hole 40 formed on the front surface and the regulation groove 41 formed on the left side surface. Furthermore, a pair of perforations 42 are formed above and below the regulation groove 41 on the left side surface of the housing 4. A holding member 43 such as a ball spring which is a combination of a sphere 430 and a holding spring 431 is arranged in the perforation 42. A substantially annular wall portion 44 is formed on the left side surface of the housing 4 to overlap the regulation groove 41. The wall portion 44 has a shape cut out by the regulation groove 41 in a straight line passing through the center in the front-rear direction. Although FIG. 5 illustrates the upper perforation 42, the sphere 430, and the holding spring 431, a similar structure is formed at a diagonally lower rear position with the wall 44 portion in between. The holding member 43 exerts a function of holding the position of the ratchet ring 7 by urging the sphere 430 toward the outside (left side) of the housing 4 with the holding spring 431 that uses a compression coil spring.

The lock guide 6, the ratchet ring 7, and the torsion spring 8 are arranged on the left side surface of the housing 4 to fit around the outer periphery of the wall portion 44, and further, the release operation part 2 for operating the torsion spring 8 is arranged.

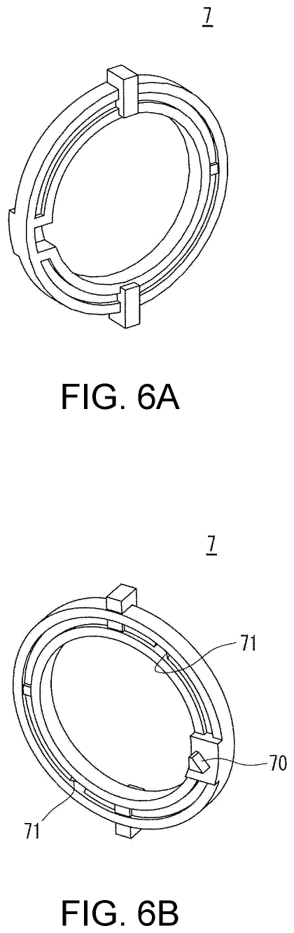

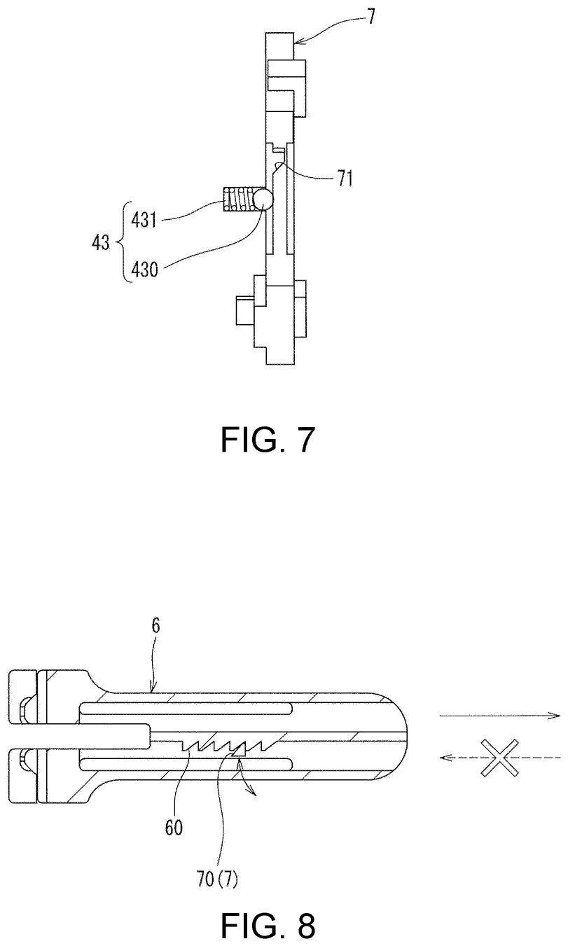

FIG. 6A and FIG. 6B are schematic perspective views showing an example of the ratchet ring 7 included in the trigger switch TS according to an embodiment of the disclosure. FIG. 7 is a schematic cross-sectional view showing an example of the ratchet ring 7 included in the trigger switch TS according to an embodiment of the disclosure. FIG. 6A shows the ratchet ring 7 from the front left perspective, and FIG. 6B shows the ratchet ring 7 from the front right perspective (the side of the housing 4). FIG. 7 shows a cross section taken from the upper holding member 43 of the housing 4 illustrated in FIG. 5 toward the lower holding member 43. In addition, in FIG. 7, the holding member 43 including the sphere 430 and the holding spring 431 of the housing 4 is shown together with the ratchet ring 7. The ratchet ring 7 will be described using FIG. 3, FIG. 6A, FIG. 6B, and FIG. 7. The ratchet ring 7 is formed in a substantially annular shape and is arranged on the left side surface of the housing 4 to be rotatable in the circumferential direction. The ratchet ring 7 has a ratchet pawl 70. The ratchet pawl 70 of the ratchet ring 7 engages with the ratchet tooth 60 of the lock guide 6 to form a ratchet mechanism that restricts the movement direction of the lock guide 6 only in the pulling direction. A fitting groove 71, into which the sphere 430 of the holding member 43 included in the housing 4 is fitted, is formed on the right side surface of the ratchet ring 7. The fitting groove 71 of the ratchet ring 7 is shallow at the position where the ratchet pawl 70 engages with the ratchet tooth 60, and becomes deep at the position where the ratchet pawl 70 disengages. The ratchet ring 7, which is rotatable in the circumferential direction, releases the ratchet mechanism from engagement when the holding member 43 is fitted into the fitting groove 71 at a deep position. The user can operate the release operation part 2 to put the holding member 43 at a shallow position in the fitting groove 71 of the ratchet ring 7, thereby bringing the ratchet mechanism into the engaged state.

The torsion spring 8 is formed in a substantially coil shape and is arranged on the left side surface of the housing 4. The torsion spring 8 presses the ratchet pawl 70 of the ratchet ring 7 in the rightward (clockwise) direction, as viewed from the left side, so as to engage with the ratchet tooth 60.

The ratchet mechanism of the trigger switch TS according to an embodiment of the disclosure will be described. FIG. 8 is a schematic view schematically showing an example of the ratchet mechanism of the trigger switch TS according to an embodiment of the disclosure. FIG. 8 schematically shows the lock guide 6 having the ratchet teeth 60, and the ratchet pawl 70 of the ratchet ring 7. FIG. 8 shows a state where the ratchet ring 7 is located at the engaged position, and the ratchet pawl 70 is urged by the torsion spring 8 to engage with the ratchet tooth 60. The ratchet teeth 60 are formed in such a shape that the rear side, which is the right side in the drawing, is inclined and the front side is vertically steep. The arrow drawn on the right side of the lock guide 6 in the drawing indicates the direction in which the lock guide 6 moves. When the trigger 1 moves in response to a pulling operation, the lock guide 6 attached to the trigger 1 also moves toward the right side in the drawing as indicated by the solid arrow. The rear side of the ratchet tooth 60 of the lock guide 6 is inclined, and the front side of the ratchet pawl 70 of the ratchet ring 7 is also inclined. Therefore, when the lock guide 6 moves toward the right side as indicated by the solid line, the ratchet pawl 70 engaged with the ratchet tooth 60 swings along the slope of the ratchet tooth 60, and when the lock guide 6 moves to the disengaged position, the ratchet pawl 70 is urged by the torsion spring 8 and swings in the opposite direction to engage with the next ratchet tooth 60. That is, the ratchet pawl 70 swings as indicated by the double arrow in the drawing. The front side of the ratchet tooth 60 of the lock guide 6 and the rear side of the ratchet pawl 70 both have a steep shape. Thus, as indicated by the broken line arrow in the drawing, the lock guide 6 does not move toward the left side even if the lock guide 6 is urged by the return spring. The ratchet ring 7 of the trigger switch TS engages with the ratchet teeth 60 of the lock guide 6 in this way to allow the lock guide 6 to move in the pulling direction and prevent the lock guide 6 from moving in the opposite direction. Therefore, when the user pulls the trigger 1 of the trigger switch TS in the engaged state illustrated in FIG. 8, the trigger 1 moves in the pulling direction and is held at any position even if the trigger 1 is released in the state of being pulled to the any position. This allows the user to perform various tasks while maintaining the power tool PT in any desired driving state.

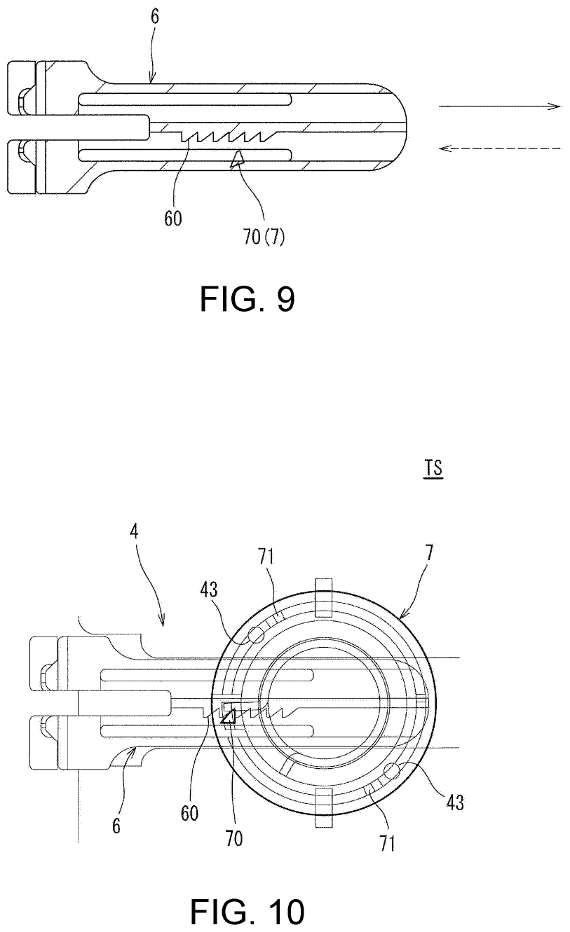

FIG. 9 is a schematic view schematically showing an example of the ratchet mechanism of the trigger switch TS according to an embodiment of the disclosure. FIG. 9 schematically shows the lock guide 6 having the ratchet teeth 60 and the ratchet pawl 70 of the ratchet ring 7. FIG. 9 shows a state where the ratchet ring 7 is rotated leftward (counterclockwise) from the state shown in FIG. 8 to release the engagement. Since the ratchet teeth 60 and the ratchet pawl 70 are released from engagement, the lock guide 6 moves freely toward the right side (the pulling direction) or the left side (the opposite direction). Therefore, when the user releases the pulling operation on the trigger 1, the lock guide 6 and the trigger 1 are urged by the return spring and move toward the left side.

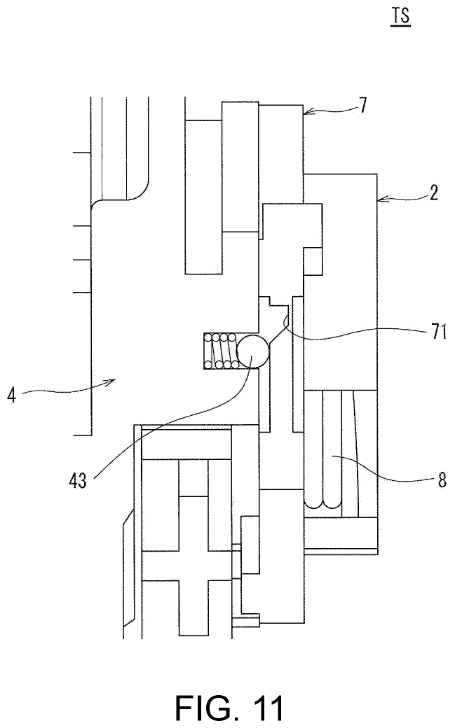

FIG. 10 is a schematic side view showing an example of the ratchet mechanism of the trigger switch TS according to an embodiment of the disclosure. FIG. 11 is a schematic cross-sectional view showing an example of the ratchet mechanism of the trigger switch TS according to an embodiment of the disclosure. FIG. 10 and FIG. 11 show the ratchet mechanism in the engaged state. FIG. 10 shows a part of the ratchet ring 7 transparently so that the positional relationship among the ratchet teeth 60 of the lock guide 6, the ratchet pawl 70 of the ratchet ring 7, and the holding member 43 of the housing 4 can be visually recognized. FIG. 11 is a cross-sectional view showing the positional relationship between the holding member 43 of the housing 4 and the fitting groove 71 of the ratchet ring 7 to be visually recognizable. When the user operates and rotates the release operation part 2 clockwise toward FIG. 10, the ratchet ring 7 linked thereto rotates clockwise, and the ratchet mechanism enters the engaged state shown in FIG. 10 and FIG. 11. In the engaged state, the ratchet teeth 60 of the lock guide 6 and the ratchet pawl 70 of the ratchet ring 7 are engaged. Further, the holding member 43 of the housing 4 is held at the shallow position in the fitting groove 71 of the ratchet ring 7, and maintains the engaged state. Therefore, when the user pulls the trigger 1 of the trigger switch TS in the engaged state illustrated in FIG. 10 and FIG. 11, the trigger 1 moves in the pulling direction and is held at any position even if the trigger 1 is released in the state of being pulled to the any position. This allows the user to perform various tasks while maintaining the power tool PT in any desired driving state.

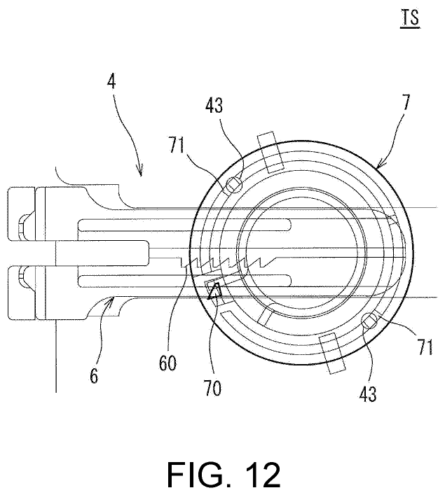

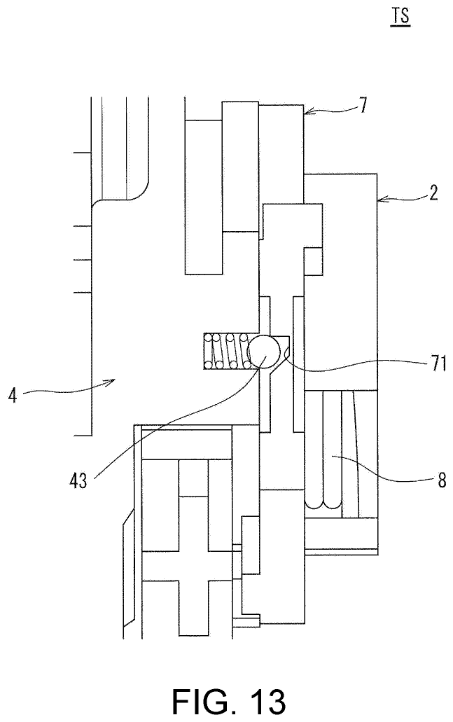

FIG. 12 is a schematic side view showing an example of the ratchet mechanism of the trigger switch TS according to an embodiment of the disclosure. FIG. 13 is a schematic cross-sectional view showing an example of the ratchet mechanism of the trigger switch TS according to an embodiment of the disclosure. FIG. 12 and FIG. 13 show the ratchet mechanism in the disengaged state. When the user operates and rotates the release operation part 2 counterclockwise from the state illustrated in FIG. 10 and FIG. 11, the ratchet ring 7 linked thereto rotates counterclockwise, and the ratchet mechanism enters the released state shown in FIG. 12 and FIG. 13. In the released state, the ratchet teeth 60 of the lock guide 6 and the ratchet pawl 70 of the ratchet ring 7 are not engaged. Further, the holding member 43 of the housing 4 moves to a deep position and fits into the fitting groove 71 of the ratchet ring 7. Therefore, in the case of the released state illustrated in FIG. 12 and FIG. 13, when the user releases the trigger 1 of the trigger switch TS, the lock guide 6 and the trigger 1 are urged by the return spring and move toward the left side, and the drive of the power tool PT is stopped.

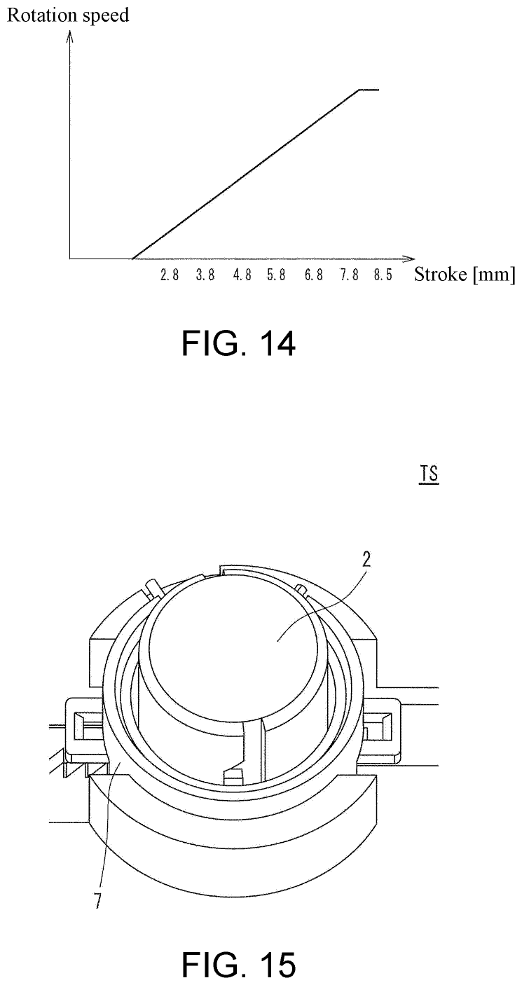

FIG. 14 is a graph showing an example of the relationship between the stroke and the rotation speed of the trigger switch TS according to an embodiment of the disclosure. FIG. 14 shows the relationship between the stroke (pulling amount) of the trigger 1 of the trigger switch TS on the horizontal axis and the rotation speed of the drive part provided in the power tool PT on the vertical axis. When the power tool PT is in a speed change mode in which the rotation speed changes according to the pulling amount of the trigger 1, the rotation speed changes corresponding to the pulling amount of the trigger 1, as illustrated in the graph of FIG. 14. Since the trigger switch TS of the disclosure is capable of holding the pulled trigger 1 at any desired position when the ratchet mechanism is in the engaged state, it is easy to operate the power tool PT while maintaining various rotation speeds such as low speed rotation and high speed rotation.

In the trigger switch TS configured as described above, the ratchet teeth 60 of the lock guide 6 and the ratchet pawl 70 of the ratchet ring 7 engage with each other, making it possible to fix the trigger 1 at any pull-in position. Therefore, excellent effects can be achieved. For example, the user can easily perform an operation to drive the drive part at any constant speed.

The disclosure is not limited to the embodiments described above, and may be implemented in various other forms. Therefore, the embodiments described above are merely illustrative in every respect, and should not be interpreted in a limiting manner. The technical scope of the disclosure is defined by the claims, and is not restricted in any way by the main text of the specification. Furthermore, all modifications and changes that come within the scope of equivalents of the claims are intended to be within the scope of the disclosure.

For example, although the above embodiment illustrates that the release operation part 2 is rotated clockwise or counterclockwise to switch between the engaged state and the released state, the trigger switch TS of the disclosure is not limited thereto, and may be developed into various forms.

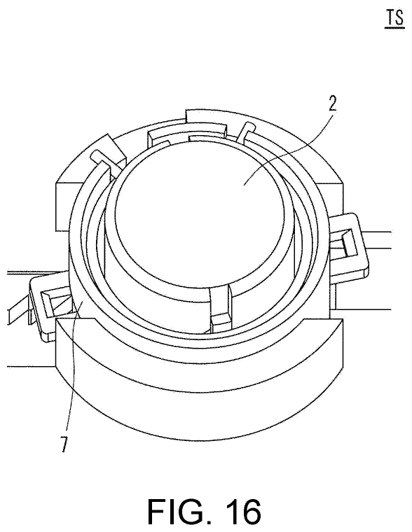

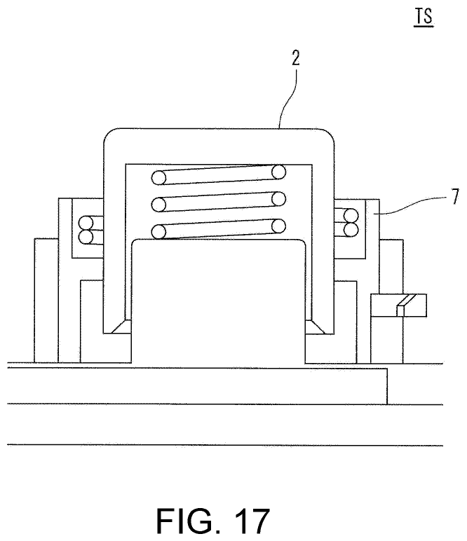

FIG. 15 and FIG. 16 are schematic perspective views showing the release operation part 2 included in the trigger switch TS according to an embodiment of the disclosure and the vicinity thereof. FIG. 17 is a schematic cross-sectional view showing the release operation part 2 included in the trigger switch TS according to an embodiment of the disclosure and the vicinity thereof. FIG. 15 to FIG. 17 illustrate another form of the release operation part 2. FIG. 15 and FIG. 17 show the engaged state while FIG. 16 shows the released state. The release operation part 2 illustrated in FIG. 15 to FIG. 17 has a groove formed oblique on the root side with respect to the height direction (left-right direction) and parallel to the height direction on the tip side, and is provided with a compression coil spring inside. Further, the ratchet ring 7 has a protrusion that engages with the groove of the release operation part 2. When the release operation part 2 illustrated in FIG. 15 to FIG. 17 is pressed, the ratchet ring 7 rotates, and the engaged state is changed to the released state. The trigger switch TS shown in FIG. 15 to FIG. 17 uses the shape of the groove and the compression coil spring to form a ballpoint pen mechanism, thereby switching between the engaged state and the released state by pressing the release operation part 2. As illustrated in FIG. 15 to FIG. 17, the release operation part 2 in the trigger switch TS of the disclosure may be developed into various forms.

Further, although the above embodiment illustrates that the elongated lock guide 6 is used as the movable engagement member, the trigger switch TS of the disclosure may use various movable engagement members. For example, the trigger switch TS of the disclosure may be developed into various forms such as using an annular movable engagement member that rotates in conjunction with the movement of the trigger 1, integrating the plunger 10 and the movable engagement member, or the like.

In other words, the trigger switch TS of the disclosure may be developed into various forms according to the following additional notes.

### (Additional Note 1)

A trigger switch, including:
a trigger that moves in a pulling direction in response to pressure of a pulling operation and moves in an opposite direction to the pulling direction in response to being released from the pressure;
a movable engagement member that moves in conjunction with movement of the trigger; and
a restraint engagement member that prevents movement of the movable engagement member in the opposite direction to the pulling direction by engaging with the movable engagement member,
wherein the restraint engagement member allows movement of the movable engagement member in the pulling direction, and
engages with the movable engagement member to prevent movement in the opposite direction from a position to which the movable engagement member is moved in the pulling direction.

### (Additional Note 2)

The trigger switch according to additional note 1, wherein the movable engagement member includes ratchet teeth arranged along a movement direction,
the restraint engagement member includes a ratchet pawl, and
the ratchet teeth of the movable engagement member and the ratchet pawl of the restraint engagement member engage so that the movable engagement member and the restraint engagement member engage.

### (Additional Note 3)

The trigger switch according to additional note 2, wherein the restraint engagement member includes an urging member that urges the ratchet pawl toward the ratchet teeth.

### (Additional Note 4)

The trigger switch according to any one of additional notes 1 to 3, further including a release operation part that receives an operation to release the movable engagement member from engagement with the restraint engagement member.

What is claimed is:

1. A trigger switch, comprising:
a trigger that moves in a pulling direction in response to pressure of a pulling operation and moves in an opposite direction to the pulling direction in response to being released from the pressure;
a movable engagement member that moves in conjunction with movement of the trigger; and
a restraint engagement member that prevents movement of the movable engagement member in the opposite direction to the pulling direction by engaging with the movable engagement member,
wherein the restraint engagement member allows movement of the movable engagement member in the pulling direction, and
engages with the movable engagement member to prevent movement in the opposite direction from a position to which the movable engagement member is moved in the pulling direction.

2. The trigger switch according to claim 1, wherein the movable engagement member comprises ratchet teeth arranged along a movement direction,
the restraint engagement member comprises a ratchet pawl, and
the ratchet teeth of the movable engagement member and the ratchet pawl of the restraint engagement member engage so that the movable engagement member and the restraint engagement member engage.

3. The trigger switch according to claim 2, wherein the restraint engagement member comprises an urging member that urges the ratchet pawl toward the ratchet teeth.

4. The trigger switch according to claim 1, further comprising a release operation part that receives an operation to release the movable engagement member from engagement with the restraint engagement member.

5. The trigger switch according to claim 2, further comprising a release operation part that receives an operation to release the movable engagement member from engagement with the restraint engagement member.
